(19) United States
(12) Patent Application Publication
(10) Pub. No.: US 2005/0117605 A1
(43) Pub. Date: Jun. 2, 2005

(54) Network address and port translation gateway with real-time media channel management

(75) Inventors: Kan Yan, San Jose, CA (US); Chih-Ping Lee, Cupertino, CA (US); Szu-Ming Lee, Shang-Keng Tsuen (TW)

Correspondence Address: TIMOTHY P. O'HAGAN, 8710 KILKENNY CT, FORT MYERS, FL, 33912, US

(73) Assignee: Innomedia Pte Ltd., The Alpha (SG)

(21) Appl. No.: 10/724,312

(22) Filed: Nov. 28, 2003

Related U.S. Application Data
(63) Continuation-in-part of application No. 10/624,256, filed on Jul. 22, 2003.

(51) Int. Cl. H04J 3/22

(52) U.S. Cl. 370/469; 370/401

(57) ABSTRACT

A gateway comprises a router module coupled between a local area network interface and a wide area network interface. The router module receives an outbound IP frame from the local area network interface and provides a corresponding translated outbound IP frame to the wide area network interface. The router module comprises a transport layer translation module for performing network address and port translation on an IP header of the outbound IP frame. The router module further comprises an application layer translation module for detecting the presence of media session signaling information within payload of the outbound IP frame and performing network address translation and port translation of source network address information identified in the media session signaling information. Both the network address and port translation of the IP header and the network address and port translation of the source network address information are recorded in a translation table such that inbound frames may be reverse translated.

### TECHNICAL FIELD

The present invention relates to network address and port translation gateways and in particular to a network address and port translation gateway that provides application layer translation to enable set up of UDP/IP channels between an IP client device and a remote IP device.

### BACKGROUND OF THE INVENTION

For many years voice telephone service was implemented over a circuit switched network commonly known as the public switched telephone network (PSTN) and controlled by a local telephone service provider. In such systems, the analog electrical signals representing the conversation are transmitted between the two telephone handsets on a dedicated twisted-pair-copper-wire circuit. More specifically, each of the two endpoint telephones is coupled to a local switching station by a dedicated pair of copper wires known as a subscriber loop. The two switching stations are connected by a trunk line network comprising multiple copper wire pairs. When a telephone call is placed, the circuit is completed by dynamically coupling each subscriber loop to a dedicated pair of copper wires in the trunk line network that completes the circuit between the two local switching stations.

A key advantage of a circuit switched network is that a dedicated circuit is continually connected between the two endpoints and capable of carrying information at a fixed rate (in this case, a voice audio signal) for the entire duration of the call. A disadvantage of a circuit switched network is the size and expense of trunk lines between switching stations that must be large enough to provide a dedicated pair of copper wires for each circuit.

More recently, telephone service has been implemented over the internet. Advances in the speed of data transmissions and internet bandwidth have made it possible for telephone conversations to be communicated using the internet's packet switched architecture and the TCP/IP protocol.

Software and hardware peripherals are available for use with personal computers which enable the two-way transfer of real-time voice information via an internet data link between two personal computers (each of which is referred to as an end point), each end point computer includes appropriate hardware for driving a microphone and a speaker. Each end point operates simultaneously as both a sender of real-time voice data and as a receiver of real-time voice data to support a full duplex voice conversation. As a sender of real-time voice data, the end point computer converts voice signals from analog format, as detected by the microphone hardware, to digital format. The software then facilitates data compression down to a rate compatible with the end point computer's data connection to an internet Service Provider (ISP) and facilitates encapsulation of the digitized and compressed voice data into the TCP/IP protocol, with appropriate addressing to permit communication via the internet.

As a receiver of real-time voice data, the end point computer and software reverse the process to recover the analog voice information for presentation to the other party via the speaker associated with the receiving computer.

In separate field of development, network address and port translation gateways (NAPT gateway) have been developed to allow multiple devices (each assigned a non-globally-unique local area network IP address) to share a single globally unique IP address assigned to the gateway. Each IP frame includes an IP header appended onto an application data object—which itself may comprise higher level headers and payload.

The IP header comprises various miscellaneous headers along with a source socket and a destination socket.

The source socket comprises a source IP address of the system which generated the IP frame. In the case of a computer coupled to a NAPT gateway, the source IP address will be a locally assigned IP address selected from a group of IP addresses reserved for use on local area networks and which are non-routable on the internet.

The source socket also comprises a TCP or UDP port number. The TCP or UDP port number is a is a logical port number assigned by the source computer and is associated with the application that generated the payload.

The destination socket comprises a destination IP address and a TCP or UDP destination port number. The destination IP address is the IP address of the remote system to which the IP frame is to be routed over the IP compliant network. The TCP or UDP destination port number is the logical port number associated with the particular application on the destination computer that is to receive the payload. The use of a destination port number enables the destination computer to route the frame to the correct application.

TCP/IP connections are typically used for data transfer where data accuracy is more important than timely delivery of frames while UDP/IP channels are typically used for real-time VoIP frames where timely delivery is more important that data accuracy. The miscellaneous headers of a UDP/IP frame are typically shorter than the headers of a TCP/IP frame.

To enable multiple devices to share a single globally unique IP address, a NAPT gateway will translate outbound frames by replacing the local source IP address with the globally unique IP address assigned by the internet service provider to the gateway and by replacing the source port number with a port number assigned by the gateway.

A record of the local source IP address, the original source port number, the translated globally unique IP address and the translated source port number are stored in a translation table. As such, when a response frame, addressed to the gateway on the port number assigned by the gateway, is received by the gateway, the gateway may reverse translate the response frame so that it may be delivered to the correct application on the correct computer on the local area network.

A challenge associated with use of an NAPT gateway with VoIP telephony is that the VoIP call set up protocols require a VoIP client to specify its IP address and its local port number for each of receiving call signaling and receiving a media session. More specifically, the VoIP client of a device will send IP frames to a remote device that include, within the frames application data object, the IP address and port numbers assigned for various purposes by the VoIP client. While the internet will route, and the NAPT gateway will properly reverse translate, a frame sent in response to the IP frame, the internet may not route and the NAPT gateway will not reverse translate any IP frames send to the specified IP address and local port of the VoIP client.

As such, a need exists for a solution that enables VoIP telephony to be provided between a device that is coupled to a local area network and is served by an NAPT gateway.

### SUMMARY OF THE INVENTION

A first aspect of the present invention is to provide a gateway for exchanging IP frames with remote IP devices over an internet service provider (ISP) communication link to a frame switched network. The gateway comprises a wide area network interface and a local area network interface. The wide area network interface is coupled to the ISP communication link for exchanging the IP frames over the internet with the remote IP devices. The local area network interface is coupled to a local area network for receiving outbound IP frames from each of a plurality of IP clients.

Each outbound IP frame comprises a local IP header and payload. The IP header comprises: i) an IP client socket which includes a client IP address and a client port number of the IP client generating the outbound IP frame and ii) a destination socket which includes a remote device IP address and a port number of a remote IP device to which the outbound IP frame is addressed.

The gateway further comprises a router module coupled between the local area network interface and the wide area network interface. The router module receives each outbound IP frame from the local area network interface and provides a corresponding translated outbound IP frame to the wide area network interface.

The translated outbound IP frame comprises a translated IP client socket which includes a gateway IP address and a global port number of the gateway that uniquely associates with the IP client socket and: i) the payload if the outbound IP frame is a data frame; and ii) translated payload if the outbound IP frame is a media session signaling frame.

A media session signaling frame comprises at least one of: i) a media session socket which includes the client IP address and a media port number of the IP client for receipt of media session frames; and ii) a signaling contact socket comprising the client IP address and a signaling port number for receipt of signaling frames.

The translated payload comprises: i) a translated media session socket if the media session signaling frame includes a media session socket; and ii) a translated signaling contact socket if the media session signaling frame includes a signaling contact socket.

The translated media session socket comprises the gateway IP address and a translated media port number that uniquely associated with the media session socket. The translated signaling contact socket comprises the gateway IP address and a translated signaling port number that uniquely associated with the signaling contact socket.

The router module further comprises a translation table for recording: i) the global port number in unique association with the IP client socket; ii) the translated media port number in unique association with the media session socket; iii) the translated signaling port number in unique association with the signaling contact socket; and a translated port number corresponding to any other source socket information that may be included in the payload. All such translations are recorded in the translation table to assure proper reverse translation of an inbound frame received on the translated port number.

The router module may comprise a frame handling module. The frame handling module may compare the payload of the outbound IP frame to a plurality of signaling frame patterns and determining that the outbound IP frame is a media session signaling frame if the payload matches a signaling frame pattern.

The router module may further comprise a payload translation database and a payload translation module. The payload translation database stores each signaling frame pattern in association with translation instructions associated with the signaling frame pattern. The payload translation module translating each socket of the payload that is identified for translation by the translation instructions.

A second aspect of the present invention is to provide a method of operating a gateway that supports multiple IP clients to effect the exchange of IP frames between each of the plurality of IP clients and remote IP devices over a communication link to a frame switched network. The method comprises receiving an outbound IP frame from each of a plurality of IP clients and providing a corresponding translated outbound to the wide area network interface.

Each outbound IP frame comprising a local IP header and payload. The local IP header comprises i) an IP client socket which includes a client IP address and a client port number of the IP client generating the outbound IP frame; and ii) a destination socket which includes a remote device IP address and a port number of a remote IP device to which the outbound IP frame is addressed.

Each translated outbound IP frame comprises a translated IP client socket which includes a gateway IP address and a global port number of the gateway that uniquely associates with the IP client socket and: i) the payload if the outbound IP frame is a data frame; and ii) translated payload if the outbound IP frame is a media session signaling frame.

Again, a media session signaling frame comprises at least one of: i) a media session socket which includes the client IP address and a media port number of the IP client for receipt of media session frames; and ii) a signaling contact socket comprising the client IP address and a signaling port number for receipt of signaling frames.

The translated payload comprises: i) a translated media session socket if the media session signaling frame includes a media session socket; and ii) a translated signaling contact socket if the media session signaling frame includes a signaling contact socket.

The translated media session socket comprises the gateway IP address and a translated media port number that uniquely associated with the media session socket. The translated signaling contact socket comprises the gateway IP address and a translated signaling port number that uniquely associated with the signaling contact socket.

The method may further comprise recording, in a translation table: i) the global port number in unique association with the IP client socket; ii) the translated media port number in unique association with the media session socket; iii) the translated signaling port number in unique association with the signaling contact socket; and a translated port number corresponding to any other source socket information that may be included in the payload. All such translations are recorded in the translation table to assure proper reverse translation of an inbound frame received on the translated port number.

The method may further comprise comparing the payload of the outbound IP frame to a plurality of signaling frame patterns and determining that the outbound IP frame is a media session signaling frame if the payload matches a signaling frame pattern.

### BRIEF DESCRIPTION OF THE DRAWINGS

FIG. 1 is a block diagram representing a system for providing VoIP communication services and internet data connectivity over a frame switched network in accordance with one embodiment of the present invention;

FIG. 2a represents exemplary steps performed to translated the IP headers of outbound frames;

FIG. 2b represents exemplary steps performed to translated the IP headers of inbound frames;

FIG. 3 is a table representing a UDP/IP translation table in accordance with one embodiment of the present invention;

FIG. 4 represents translations performed by an exemplary routing module of the present invention;

FIG. 5 is a flow chart representing exemplary operation of a frame handling module in accordance with one embodiment of the present invention;

FIG. 6 is a table representing an exemplary payload translation database in accordance with one embodiment of the present invention;

FIG. 7 is a flow chart representing exemplary operation of a payload network address and port translation module in accordance with one embodiment of the present invention;

FIG. 8a is a table representing an outbound IP frame comprising a SIP Invite Message in accordance with one embodiment of the present invention;

FIG. 8b is a table representing a translated outbound IP frame comprising a translated SIP Invite Message in accordance with one embodiment of the present invention;

FIG. 9a is a table representing an outbound IP frame comprising a SIP Register Message in accordance with one embodiment of the present invention;

FIG. 9b is a table representing a translated outbound IP frame comprising a translated SIP Register Message in accordance with one embodiment of the present invention;

FIG. 10a is a table representing an outbound IP frame comprising a SIP OK Response Message in accordance with one embodiment of the present invention; and

FIG. 10b is a table representing a translated outbound IP frame comprising a translated SIP OK Response Message in accordance with one embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

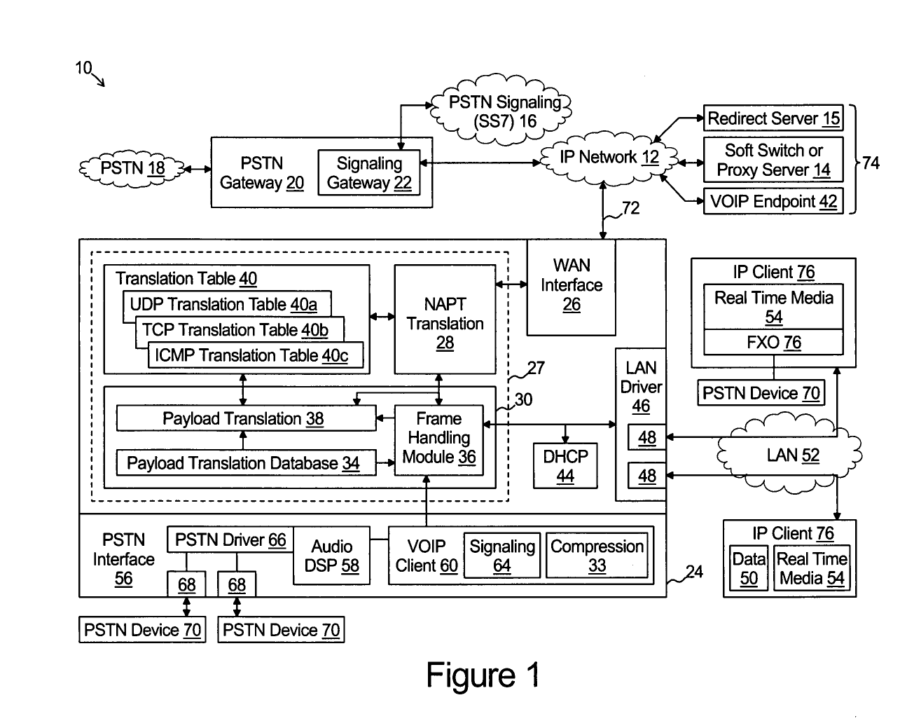

FIG. 1 represents a system 10 for providing both real-time media communications, such as internet voice telephone (VoIP) and internet data connectivity to a plurality of IP clients 76 over a frame switched network 12 such as the internet (herein after referred to as the internet 12).

A gateway 24 is coupled to the internet 12 via an internet service provider (ISP) link 72. The gateway 24 manages a local area IP network (LAN) 52 which interconnects the gateway 24 with each of the IP clients 76. Also coupled to the internet 12 are a plurality of remote devices 74 which, for purposes of this invention, may comprise a soft switch or proxy server 14, a redirect server 15, a PSTN gateway 20, and a remote VoIP endpoint 42.

The soft switch or proxy sever 14 may be a known system that provides the proxy server functions of the various Session Initiation Protocols (SIP) or the call agent functions of the Multimedia Gateway Control Protocols (MGCP) for signaling VoIP media sessions.

The redirect server 15 may be a known system that provides redirect functions of the SIP protocols or otherwise provides a directory that maps a media session client's permanent identification with an IP address for signaling the client.

The PSTN gateway 20 may be a known trunking gateway for interfacing between PSTN call legs (e.g. call sessions over the PSTN 18) and VoIP call legs (e.g. call sessions utilizing VoIP point-to-point logical channels between the PSTN gateway 20 and an IP client 76). The PSTN gateway 20 may include (or be associated with) a known signaling gateway 22 for interfacing with a PSTN signaling network (e.g. SS7 network) 16.

Each of the IP clients 76 may comprise a real-time media client 54 and optionally one or more data clients 50. The real-time media client 54 may be a SIP user agent system or other client system compatible with the MGCP, H.323, or other real-time media session signaling protocol. A data client 50 may be a web browser, an email client, or any other software system that exchanges data with remote devices using IP protocols.

An IP client 76 may be embodied in a PC or other computing device capable of operating the real-time media client 54 and the data clients 50 as well as operating an IP stack for enabling each of the media client 54 and the data clients 50 to exchange data with remote IP devices 74 over IP enabled networks such as the LAN 52 and the internet 12.

In an alternative, an IP client 76 may be an adapter appliance which operates a real-time media client 54 and operates an FXO module 76 for supporting a standard PSTN telephony device 70 such as a telephone handset or fax machine. The adapter appliance interfaces between PSTN telephony media and signaling with the PSTN telephony device 70 and VoIP media and signaling over the LAN 52 and the internet 12.

Gateway

The gateway 24 operates as a network address and port translation gateway for the plurality of IP clients 76. Optionally, the gateway 24 may include a PSTN interface 56 and operate as a PSTN gateway for the plurality of PSTN devices 70 coupled to the gateway 24.

The gateway 24 includes the PSTN interface 56, a WAN interface 26, a Dynamic Host Configuration Protocol (DHCP) server 44, a local area network interface 46, and a routing module 27.

The WAN interface 44 utilizes known physical layer protocols which are compliant with those utilized by the ISP link 72 such that IP frames may be exchanged between the gateway 24 and the remote IP devices 74 over the internet 12.

The LAN interface module 46 comprises one or more network ports 48. Each network port 48 enables the exchange of IP frames between the gateway 24 and one of the IP clients 76 over the LAN 52. In the exemplary embodiment, the LAN interface module 46 may operate as an Ethernet switch and each network port 48 provides an Ethernet compliant downlink connection for one of the IP clients 76.

The DHCP server 44 is a known server technology that dispenses IP addresses (from within a subset of IP addresses that are reserved for local area network use). The DHCP server 44 dispenses a local area network client IP address to each of the IP clients 76 and to a VoIP client 60 of the PSTN interface 56.

Routing Module

The routing module 27 operates as a root node of the LAN 52. The routing module 27 provides IP layer network address and port translation services to enable each of the multiple IP clients 76 (and the VoIP module 60) to exchange TCP/IP frames, UDP/IP frames and ICMP/IP frames with remote IP devices 74 sharing only a single IP address assigned to the gateway 24 by the ISP.

In addition to providing IP layer network address and port translation services, the routing module 27 provides payload translation services to enable each of the multiple IP clients 76 (and the VoIP module 60) to establish UDP/IP channels through the gateway 24 (in addition to the IP channels established by the IP layer translation) to support in bound media session signaling and inbound real-time transport protocol media sessions.

The routing module 27 comprises a network address and port translation (NAPT) module 28, an application layer translation module 30, and a translation table 40. The NAPT module 28 comprises known network address and port translation technology for: i) translating the TCP/IP, UDP/IP, and ICMP/IP headers of outbound frames sent by an IP client 76; and ii) reverse translating and routing inbound frames received from the internet 12 on an open channel recorded in the translation table 40.

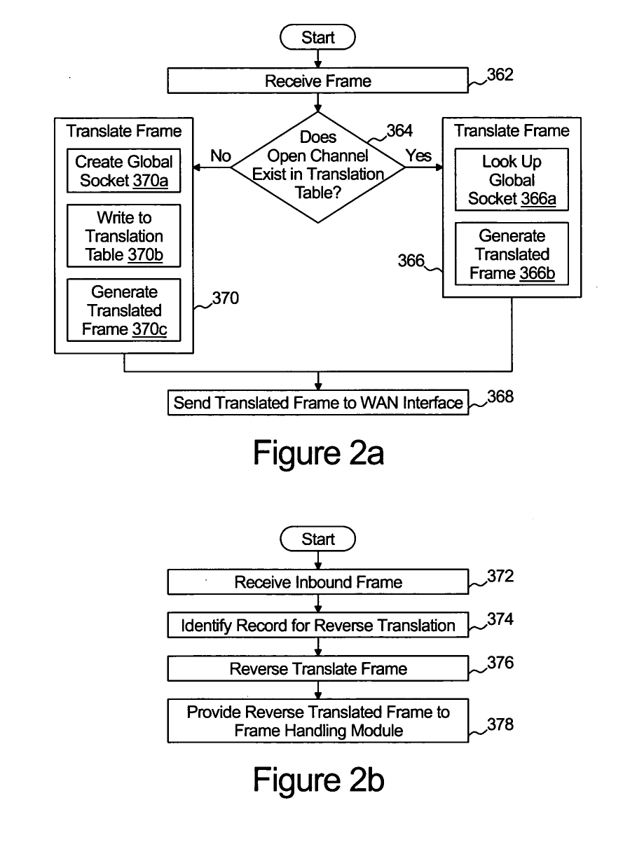

More specifically, referring to FIG. 2a, translating the IP header of an outbound frame sent an IP client 76 or the VOIP module 60 comprises receiving the frame from the application layer translation module 30 at step 362. Step 364 represents determining whether an open channel for the frame already exists in the translation table 40.

The translation table 40 comprises each of a UDP translation table 40a, a TCP translation table 40b, and an ICMP translation table 40c. Each table includes similar structure for associating, for each open channel, local socket information with global socket information.

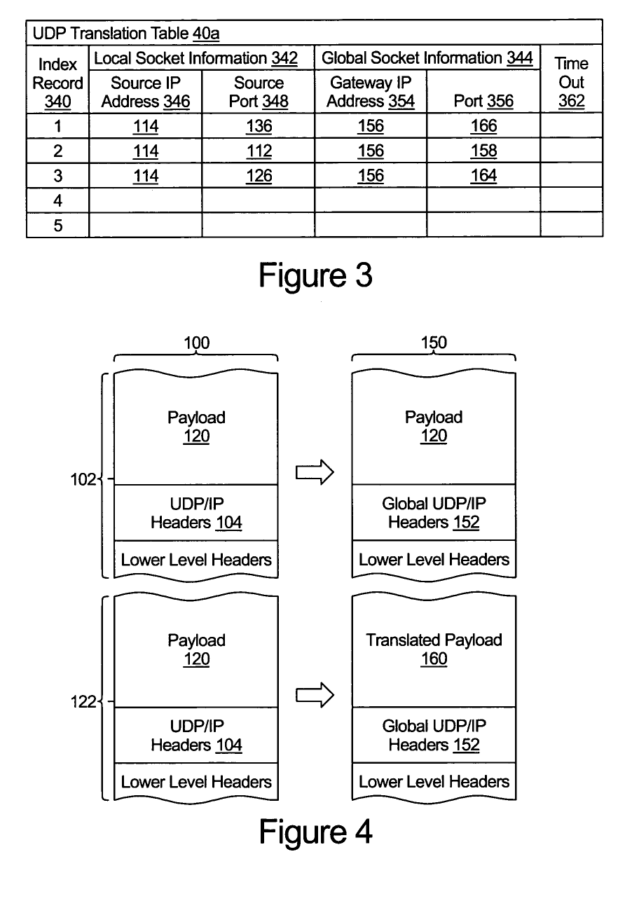

For example, referring briefly to FIG. 3, the UDP/IP translation table 40a is shown. The translation table 40a includes a plurality of records 340, each defining an open channel. Each open channel associates a local socket information field 342 with the translated global socket information field 344. The local socket information field 342 comprises at least a source IP address field 346 and a source port field 348 which store the local area network client IP address and port number of the IP client 58 (or the VoIP client 60) initiating the outbound frame. The global socket information field 344 comprises at least a global port field 356 and—if the gateway 24 has more than one IP address available for IP address translation, a global IP address field 354 which store the IP address and port number utilized by the gateway 24 for initiating the translated frame on the internet 12. The translation table 40a may also include a time out field for storing an indicator of how long the open channel should remain open for reverse translation of inbound IP frames.

Returning to FIG. 2a, the step of determining whether an open channel for the frame exists in the translation table 50 (e.g. step 364) comprises comparing the source IP address and port number of the received frame with IP addresses and port numbers in the local socket information field 342 of each record (in the TCP, UDP, or ICMP table that matches the frame type). An open channel exists if the if the source IP address and port number of the frame matches the IP address and port number in field 342 of one of the records (the existing record). Alternatively, if there is no match, an open channel does not yet exist.

Step 366 represents translating the outbound frame utilizing an existing open channel. More specifically, the NAPT translation module 28 looks up the global IP address and port number in the global socket information field 342 in the existing record at step 366a.

Step 366b represents generating the translated frame with the global IP address and port number replacing the local IP address and port number in the source IP address field and source port field of the outbound frame. The translated frame is then provided to the WAN interface 26 at step 368 for routing on the internet 12.

Step 370 represents translating the outbound frame if an open channel does not exist. More specifically, the NAPT translation module 28 selects a global port (and a global IP address if the gateway 24 has more than one IP address available for IP address translation) to create the global IP address and port for translation.

Step 370b represents writing the newly created global IP address and port to the global socket information field 344 of a new record in the translation table 40a. In conjunction with writing the global IP address and port to the global socket information field, the local source IP address and socket are written to the local socket information field 342 of the new record.

Step 370c represents generating the translated frame with the newly created global IP address and port number replacing the local IP address and port number in the source IP address field and source port field of the outbound frame. The translated frame is then provided to the WAN interface 26 at step 368 for routing on the internet 12.

Referring to FIG. 2b, reverse translation and routing of an inbound frame received from the internet 12 comprises the NAPT translation module 28 receiving the inbound frame at step 372.

Step 374 represents identifying the record in the translation table 40 for use reverse translating the frame by locating the record that includes (in the global socket information field 344) an IP address and port number that matches the destination IP address and port number of the inbound frame (the matching record).

Step 376 represents reverse translating the frame by replacing the destination IP address and port number with the local network IP address and port number retrieved from the local socket field 342 of the matching record.

Step 378 represents providing the reverse translated frame to the frame handling module for subsequent routing to the VoIP module 60 or to the LAN module 48 (and subsequent routing to an IP client 76.

Returning to FIG. 1, the application layer translation module 30 comprises a frame handling module 36, a payload translation module 38, and a payload translation database 34. The application layer translation module 30 translates local IP sockets that are identified in the payload of outbound real-time media session signaling frames to generate translated sockets. The application layer translation module 30 records each such translation as an open channel in the translation table 40 to assure that: i) any outbound frame using the local IP address and port in its source IP address and port fields is translated utilizing the existing open channel step 366 as discussed with respect to FIG. 2a; and ii) any inbound frame addressed to the translated socket is properly routed by the NAPT module 28 as previously discussed with respect to FIG. 2b.

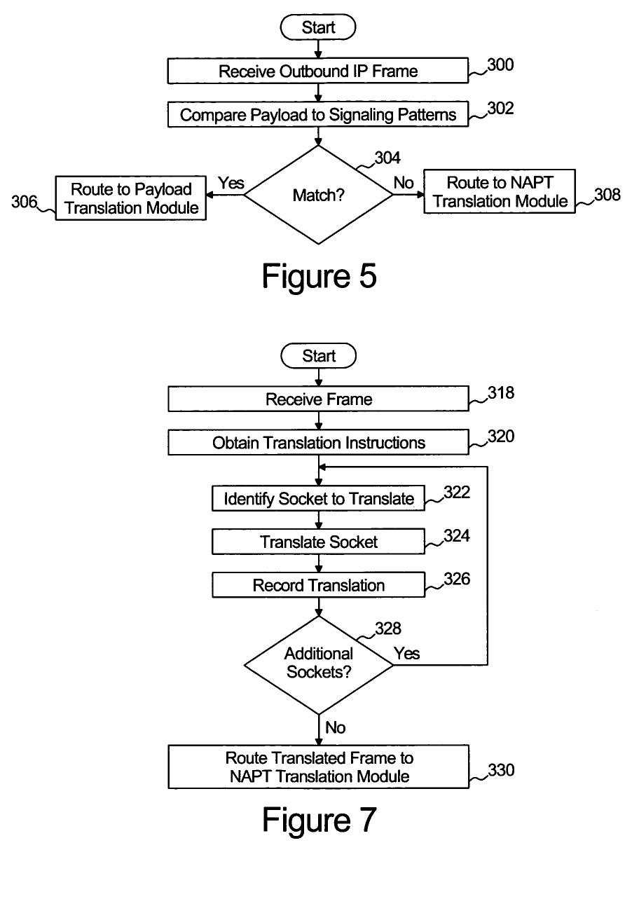

Referring briefly to FIG. 4 in conjunction with FIG. 1, the frame handling module 36 receives each outbound IP frame 100 generated by any of the IP clients 76 or the VoIP client 60. Each outbound IP frame 100 comprises IP layer headers 104 and payload 120. If the outbound IP frame 100 is a data frame 102, then the payload 120 may be data (either real-time media data or other data) transferred over a TCP/IP connection or a UDP/IP channel. Alternatively, if the outbound IP frame 100 is a media session signaling frame 122, then the payload 120 may be a real-time media session signaling message identifying local IP sockets such as a media session socket 127 or a signaling contact socket 124—each of which is discussed herein.

The frame handling module 36 passes each data frame 102 directly to the NAPT module 28 without payload translation such that the translated frame 150 comprises the payload 120 with global IP headers 152 replacing the IP headers 104. The frame handling module 36 passes each media session signaling frame 122 to the payload translation module 38 which, in turn, translates local sockets identified in the payload 120 to generate translated payload 160. The frame with translated payload 160 is then passed to the NAPT module 28 such that the translated frame 150 comprises translated payload 160 with global IP headers 152 replacing the IP headers 104.

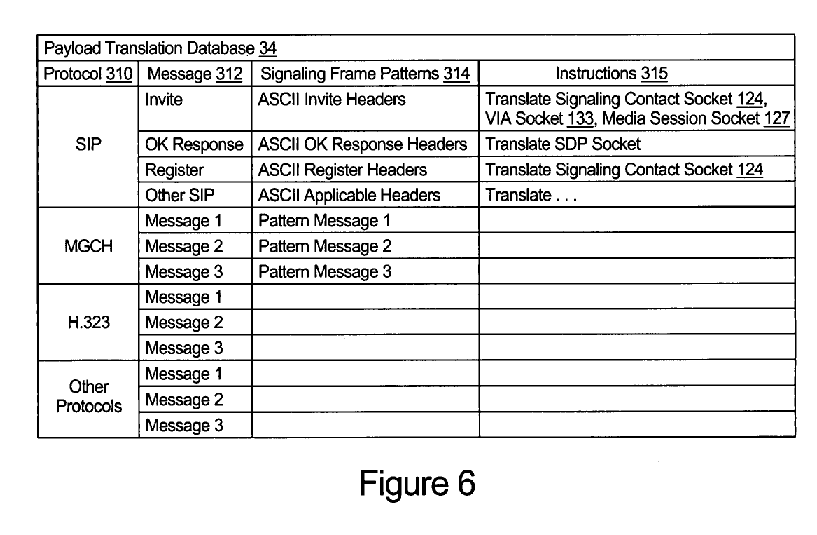

The flow chart of FIG. 5, shows exemplary operation the frame handling module 36. Referring to FIG. 5 in conjunction with FIG. 1, step 300 represents receiving an outbound IP frame 100 from either the local area network module 46 or the VoIP client 60. Step 302 represents comparing the payload 120 of the outbound IP frame 100 to real-time media session signaling patterns 314 retrieved from the payload translation database 34 to determine whether the payload 120 represents a real-time media session signaling message.

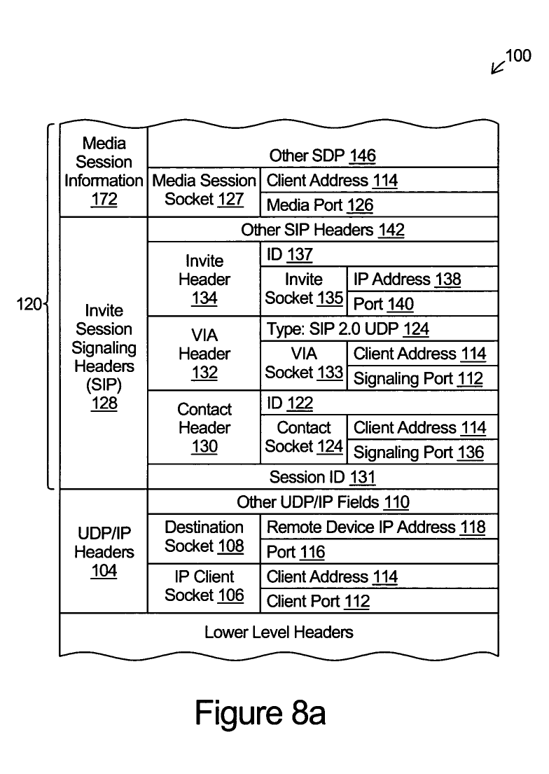

FIG. 6 represents an exemplary structure of a payload translation database 34. The database 34 stores a record for each defined message 312 of each of a plurality of signaling protocols 310 such as the SIP, MGCP, H.323 and other signaling protocols that may be developed and/or become more popular in the future. In association with each defined message 312 is a signaling frame pattern 314 and payload translation instructions 315.

The signaling frame pattern 314 is data useful by the frame handling module 36 for detecting whether payload 120 of an outbound IP frame 100 is the defined signaling message. For example, the signaling frame pattern 314 for a SIP invite message may be ASCII text patterns of the SIP Headers of the SIP invite message. As such, when the frame handling module 36 detects ASCII text character patterns that match the character patterns of the signaling frame pattern 314 for the SIP invite message, the frame handling module 36 can conclusively determine that the payload 120 is a SIP invite message. The translation instructions 315 identify each socket within the message that requires translation and recording in the translation table 40.

Returning to FIG. 5, after comparing the payload 120 of the outbound IP frame 100 to the signaling frame patterns 314 at step 302, the frame handling module 36 determines whether the payload 120 matches one of the patterns 314 at step 304. If it does not match one of the patterns 314, then the frame 100 is determined to be a data frame 102 and is routed to the NAPT module 28 at step 306. Alternatively, if the payload 120 matches one of the patterns 314, then the frame 100 is determined to be a real-time media session signaling frame 122 and is routed to the payload translation module 38 at step 308.

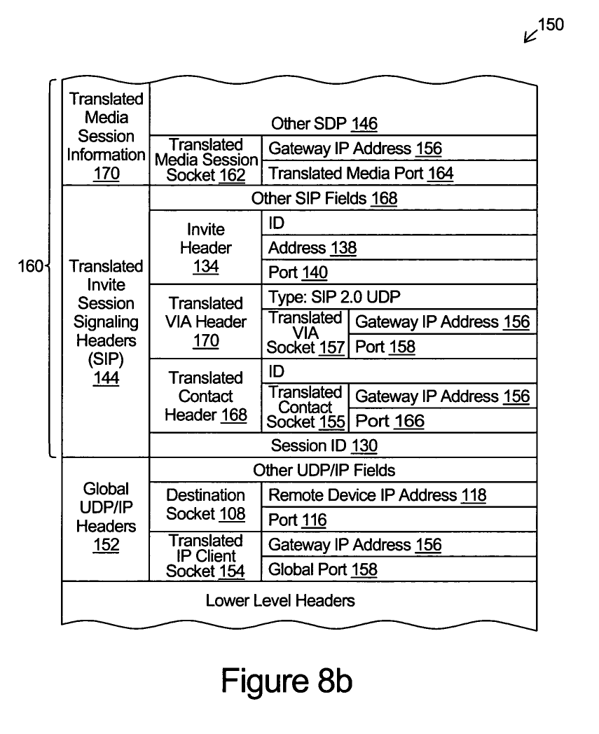

The flow chart of FIG. 7 represents exemplary operation of the payload translation module 38. Step 318 represents receiving the outbound IP 100 frame from the frame handling module 36. Step 320 represents obtaining translation instructions 315 that correspond to the message type 312 from the payload translation database 34.

The translation instructions 315 identify each local socket within the payload 120 that requires translation. For example: i) a SIP Invite message requires translation of the signaling contact socket 124, the most recent via socket 133, and the media session socket 127 (e.g. the socket identified for the media session in the session description protocol); ii) a SIP OK Response message requires translation of the media session socket 127; and iii) a SIP register message requires translation of the signaling contact socket 124.

Returning to FIG. 7, step 322 represents identifying a socket within the message that requires translation using the translation instructions 315 obtained at step 320. For example, in the case of a SIP invite message, the first socket identified for translation may be the signaling contact socket 124. Step 324 represents translating the identified socket by substituting: i) the client IP address with the gateway IP address as assigned by the ISP; and ii) the port number established by the real-time media client 54 (or the VoIP client 60) with a gateway dynamic port available for port translation.

Step 326 represents recording the translation in the translation table 40 to open the translated channel for inbound IP frames. After recording the translation in the translation table 40, an inbound IP frame addressed to the gateway IP address and the gateway dynamic port will be reverse translated and routed to the client IP address and port by the NAPT translation module 28 in the same manner as the NAPT translation module 28 would reverse translates and route a frame addressed to an open channel that is recorded in the translation table 40 by the NAPT translation module 28 during the IP header translation processes.

Step 328 represents determining whether the message includes additional sockets that require translation. If there are additional sockets requiring translation, the payload translation module 38 returns to step 322 to begin translation of the next identified socket. After all sockets requiring translation have been translated, the payload translation module routes the translated frame to the NAPT module 28.

As previously discussed, the NAPT module 28 performs appropriate network address and port translation of the IP headers and routes the frame to the internet 12.

Exemplary Operation, Outbound Session Signaling

For purposes of example, operation of the present invention is herein described for SIP media session signaling and media session set up between an initiating IP device 76 and a terminating remote VoIP device 42. However, those skilled in the art will appreciate that the present invention is not limited to sue with SIP protocols and can readily be applied to systems utilizing MGCP, H.323, and other real-time media session signaling protocols.

To initiate a real-time media session, the SIP protocol provides for a first SIP user agent (e.g. a caller) to send an invite message identifying a second SIP user agent (e.g. a callee) by a unique identifier such as a SIP URL.

The invite message is a UDP/IP message addressed and routed to a SIP proxy server. The SIP proxy server obtains the current IP address of the callee SIP user agent from a redirect server and then forwards an invite message to the callee SIP user agent.

In response, the callee SIP user agent returns a SIP OK Response message back to the caller user agent at a SIP signaling contact socket identified in the invite message. Each of the SIP invite message and the SIP OK Response message identify a media session socket established by the caller SIP user agent and the callee SIP user agent respectively for receiving real-time media from the other user agent.

The media session socket established by the caller SIP user agent includes the IP address of the caller SIP user agent and a port number established by the caller SIP user agent for receipt of real-time streaming media from the caller. Similarly, the media session socket established by the callee SIP user agent includes the IP address of the callee SIP user agent and a port number established by the callee SIP user agent for receipt of real-time streaming media from the callee.

After the caller SIP user agent receives the SIP OK Response message, the two user agents begin sending real-time media frames to each other on the identified media session sockets.

For purposes of illustrating outbound session signaling in accordance with the present invention, the IP client 76 operates as the first SIP user agent or caller and the VoIP endpoint 42 operates as the second SIP user agent or callee.

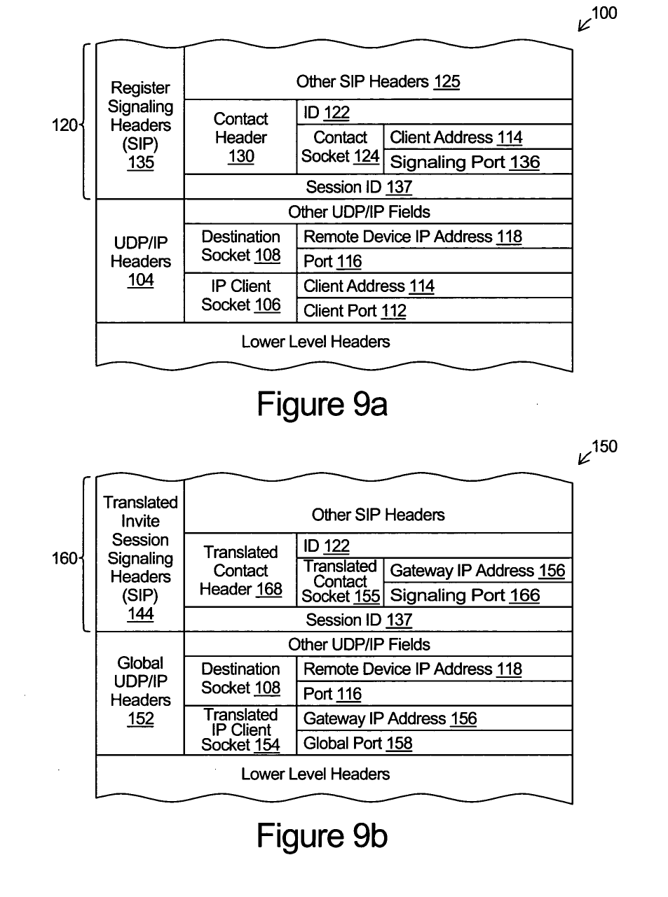

The table of FIG. 8a represents an exemplary outbound IP frame 100 that includes UDP/IP headers 104 and a SIP invite message in the payload 120. The UDP/IP headers 104 comprise an IP client socket 106 (e.g. source socket) a destination socket 108, and other UDP/IP fields 110. The IP client socket 106 identifies the IP address 114 of the IP client 76 on the local area network 52 and a port number 112 used by the IP client 76 for sending the IP frame 100.

The destination socket 108 identifies a remote device IP address 118 of the VoIP endpoint 42 to which the outbound IP frame 100 is to be routed and a destination port number 116 which is a port number associated with a real-time media application to which the payload 120 is to be routed after the frame 100 is received by the VoIP endpoint 42. In this example, the remote device IP address 118 will be the IP address of the proxy server 14 and the port number 116 will be a port number established by the proxy server for receipt of invite messages.

The payload 120 comprises invite session signaling headers 128 and media session information 172 which may comply with the Session Description Protocol (SDP).

The invite session signaling headers 128 comprises a session ID 131, contact header 130, a via header 132, an invite header 134, and other applicable SIP headers 142. The contact header 130 labels a unique ID number of the IP client 76 generating the invite message and a contact socket 135. The contact socket 124 comprises the client IP address 114 and a signaling port number 136 selected by the IP client 76 for receipt of real-time media session signaling messages.

The via socket 132 labels a type field 124 and a via socket 133. The via socket 133 comprises the client IP address 114 and the client port number 112.

The invite header 134 labels a unique ID number of the remote VoIP endpoint 42 to which the invite message is to be routed as well as an invite socket 135. The invite socket 135 comprises the IP address 138 and port number 140 of the proxy server 14 supporting the IP client 76.

The media session information 172 may comprise a media session socket 177 as well as various SDP information 146. The media session socket 177 comprises the client IP address 114 and a media port number 126 established by the IP client 76 for receipt of real-time media during the media session.

As previously discussed with reference to the flow chart of FIG. 5, the frame handling module 36 will identify the outbound IP frame 100 as containing a SIP invite message within the payload 120 and will route the frame to the payload translation module 38.

Upon receipt of the outbound IP frame 100, the payload translation module 38 will translate the payload 120 in accordance with translation instructions 315 from the payload translation database 34 to generate translated payload 160.

The table of FIG. 8b represents a translated IP frame 150 which includes the translated payload 160 and translated IP headers 152 (as translated by the NAPT translation module 28).

As previously discussed with reference to the flow chart of FIG. 7, the payload translation module 38 will translate each of the contact socket 124, the via socket 133, and the media session socket 127 of a SIP invite message. As such, the invite message of the translated payload 160 includes all of the same fields as the invite message of the payload 120 except for a translated contact socket 155, a translated via socket 157, and a translated media session socket 162 replacing each of the contact socket 124, the via socket 133, and the media session socket 127 respectively.

The translated contact socket 155 comprises the gateway IP address 156 and a dynamic port 166 of the gateway 24 that may be used for sending SIP session signaling messages to the IP client 76. The translated via socket 157 comprises the gateway IP address 156 and a dynamic port 158 of the gateway 24.

The translated media session socket 162 comprises the gateway IP address 156 and a dynamic port number 164 of the gateway that may be used for sending real-time media to the IP client 76 during the media session.

As previously discusses with reference to the flow chart of FIG. 7, the translation of each of the contact socket 124, the via socket 133, and the media session socket 127 of a SIP invite message will be recorded as an open channel in the UDP/IP translation table 40a.

Referring briefly to FIG. 3, the first of the records 340 in the translation table 40a represents the open channel created by recording the translation of the contact socket 124. The local socket information 342 of the channel comprises the client IP address 114 and the signaling port number 136 stored within the source IP address field 346 and the source port number field 348 respectively. The global socket information 344 comprises the gateway IP address 156 and the dynamic port number 166 stored within the source IP address field 354 and the source port number field 356 respectively.

The second of the records 340 in the translation table 40a represents the open channel created by recording translation of the via socket 133. The local socket information 342 of the channel comprises the client IP address 114 and the port number 112 stored within the source IP address field 346 and the source port number field 348 respectively. The global socket information 344 comprises the gateway IP address 156 and the dynamic port number 158 stored within the source IP address field 354 and the source port number field 356 respectively.

The third of the records 340 in the translation table 40a represents the open channel created by recording translation of the media session socket 127. The local socket information 342 of the channel comprises the client IP address 114 and the media port number 126 stored within the source IP address field 346 and the source port number field 348 respectively. The global socket information 344 comprises the gateway IP address 156 and the dynamic port number 164 stored within the source IP address field 354 and the source port number field 356 respectively.

As previously discussed with reference to the flow chart of FIG. 7, after the open channel has been recorded within the translation table 40a, the frame 100 is passed to the NAPT translation module 28 for translation of the IP headers. Because the IP client socket 106 is already a socket that is recorded in the translation table 40a (by virtue of the payload translation module 38 translating the via socket 133), the NAPT translation module 28 will utilize the global socket information 344 of the translation table 40a for translating the IP header 104 of the outbound IP frame 100.

At some future time, the remote endpoint 42 will return an OK Response message back to the IP client 76. Because the remote endpoint 42 will have received the translated invite message (with modifications that may be made by various proxy servers) the remote endpoint 42 will address the OK Response message to the IP client 76 utilizing the translated contact socket 155—which includes the gateway IP address 156 and port 166.

By virtue of the contact socket translation being entered into the UDP/IP translation table 40a by the payload translation module 38, the OK Response frame will be appropriately reverse translated and routed by the NAPT module 28.

Following the OK Response message, each of the IP device 76 and the remote VoIP endpoint 42 will begin sending media frames to each others media session socket. Because the remote VoIP endpoint 42 will have received the translated invite message 160, it will be sending media frames to the translated media session socket 162. Again, by virtue of the media session socket translation being written to the UDP/IP translation table 40a, each media frame sent to the translated media session socket 162 will be appropriately reverse translated and routed by the NAPT module 28.

Exemplary Operation, Inbound Session Signaling

For purposes of illustrating inbound session signaling, the remote IP endpoint 42 operates as the first SIP user agent or caller and the IP client 76 operates as the second SIP user agent or callee.

As previously discussed, a SIP redirect server provides the current IP address of a callee user agent. As such, each SIP user agent, such as the IP device 76, must periodically register its contact socket with a SIP redirect server.

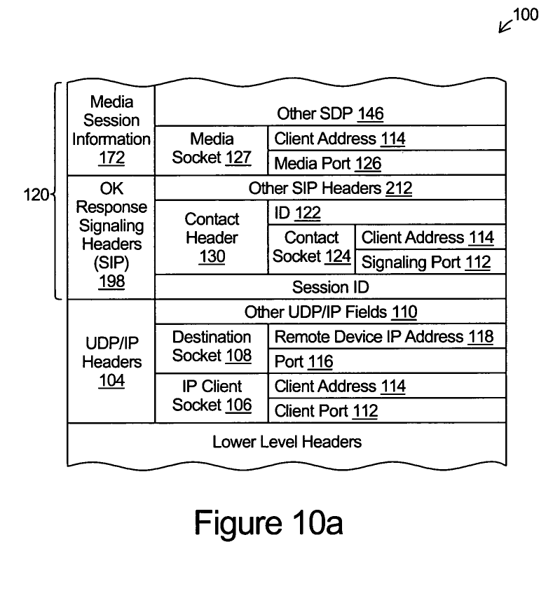

The table of FIG. 9a represents an outbound IP frame 100 that includes UDP/IP headers 104 and an exemplary SIP Register message in the payload 120. Such a frame 100 is periodically generated by the IP client 76 to register itself with the redirect server 15.

The payload 120 comprises register signaling headers 135 which includes a session ID header 137, a contact header 130, and other applicable SIP headers 125. As discussed, the contact header 130 labels the unique ID of the IP client 76 and the contact socket 124 which, as discussed, comprises the client IP address 114 and a port number assigned by the IP client 76 for receipt of SIP media session signaling messages.

As previously discussed with reference to the flow chart of FIG. 5, the frame handling module 36 will identify the outbound IP frame 100 as containing a SIP Register message within the payload 120 and will route the frame 100 to the payload translation module 38.

Upon receipt of the outbound IP frame 100, the payload translation module 38 will translate the payload 120 in accordance with translation instructions 315 from the payload translation database 34 to generate translated payload 160.

The table of FIG. 9b represents a translated IP frame 150 which includes the translated payload 160 and translated IP headers 152 (as translated by the NAPT translation module 28).

As previously discussed with reference to the flow chart of FIG. 7, the payload translation module 38 will translate the contact socket 124 of a SIP Register Message. As such, the SIP Register Message of the translated payload 160 includes all of the same fields as the SIP Register Message of the payload 120 except for a translated contact socket 155 replacing the contact socket 124. The translated contact socket 155 comprises the gateway IP address 156 and a dynamic port 166 of the gateway 24 that may be used for sending SIP session signaling messages to the IP client 76.

As previously discusses with reference to the flow chart of FIG. 7, the translation of the contact socket 124 will be recorded in the UDP/IP translation table 40a—if such a translation does not already exist in the UDP/IP translation table 40a.

After the translation has been recorded within the translation table 40a, the frame 100 is passed to the NAPT translation module 28 for translation of the IP headers 104.

At some future time, the remote endpoint 42 may initiate a real-time media session to the IP client 76 by sending an SIP invite message that is routed to the translated contact socket 155. By virtue of the contact socket translation being entered into the UDP/IP translation table 40a by the payload translation module 38, the SIP Invite Message will be appropriately reverse translated and routed to the IP client 76 by the NAPT module 28.

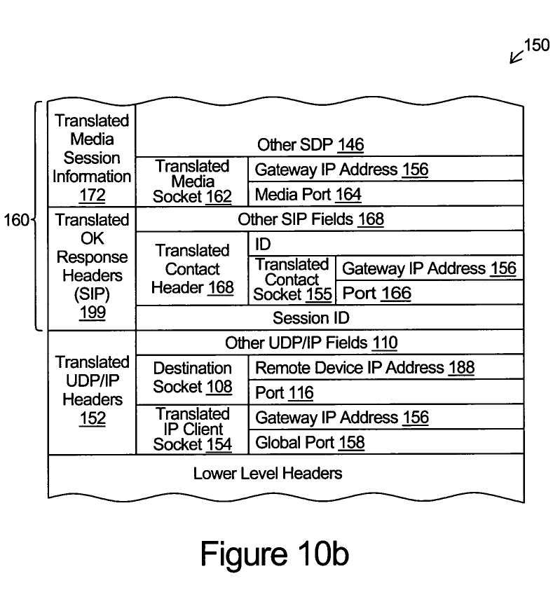

At some time after receiving the SIP Invite Message, the IP client 76 will respond with a SIP OK Response Message. The table of FIG. 10a represents an outbound IP frame 100 that includes UDP/IP headers 104 and an exemplary SIP OK Response message in the payload 120.

The payload 120 comprises OK Response signaling headers 198 and media session information 172. The SIP OK Response Headers 198 comprises a session ID 131, a contact header 130, and other applicable SIP headers 212. The session ID 131 will be the session ID number generated by the remote VoIP device 42 and included in the SIP Invite message. The contact header 130 labels the unique ID number of the IP client 76 generating the OK Response Message 180 and the contact socket 124 of the IP client 76. As previously discussed, the contact socket 124 comprises the client IP address 114 of the IP client 76 and a signaling port number 136 selected by the IP client 76 for receipt of real-time media session signaling messages.

The media session information 172 comprises the media session socket 127 as well as various SDP information 146. The media session socket 127 comprises the client IP address 114 and a media port number 126 established by the IP client 76 for receipt of real-time media during the media session.

As previously discussed with reference to the flow chart of FIG. 5, the frame handling module 36 will identify the outbound IP frame 100 as containing a SIP OK Response message within the payload 120 and will route the frame to the payload translation module 38.

Upon receipt of the outbound IP frame 100, the payload translation module 38 will translate the payload 120 in accordance with translation instructions 315 from the payload translation database 34 to generate translated payload 160.

The table of FIG. 10b represents a translated IP frame 150 which includes the translated payload 160 and translated IP headers 152 (as translated by the NAPT translation module 28).

As previously discussed with reference to the flow chart of FIG. 7, the payload translation module 38 will translate each of the contact socket 124 and the media session socket 127 of a SIP OK Response Message. As such, the translated OK Response Message of the translated payload 160 includes all of the same fields as the OK Response Message of the payload 120 except for a translated contact socket 155 and a translated media session socket 162 replacing each of the contact socket 124 and the media session socket 127 respectively.

As previously discusses with reference to the flow chart of FIG. 7, the translation of each of the contact socket 124 and the media session socket 127 will be recorded in the UDP/IP translation table 40a—if such translations have not previously been recorded by in the UDP/IP translation table 40a.

After the translation has been recorded within the translation table 40a, the frame 100 is passed to the NAPT translation module 28 for translation of the IP headers.

Following the OK Response message, each of the IP device 76 and the remote VoIP endpoint 42 will begin sending media frames to each others media session socket. Because the IP device 76 received a SIP Invite Message from the remote VoIP endpoint 42, the IP device 76 will be able to address media frames to the media session socket identified in such SIP Invite Message. Because the remote VoIP endpoint will have received the translated OK Response Message, it will be sending media frames to the translated media session socket 162 identified in the translated SIP OK Response Message. By virtue of the media session socket translation being written to the UDP/IP translation table 40a, each media frame sent to the translated media session socket 162 will be appropriately reverse translated and routed by the NAPT module 28.

PSTN Interface Module

Returning to FIG. 1, The PSTN interface module 56 comprises the VoIP client 60, the plurality of PSTN ports 68, a PSTN driver module 66, and an audio DSP 58.

The PSTN driver module 66 emulates a PSTN subscriber loop on each PSTN port 68 for interfacing with a traditional PSTN device 70 utilizing in-band analog or digital PSTN signaling. The audio DSP 58 interfaces between the PSTN driver module 66 and the VoIP client 60. The Audio DSP 58: i) detects PSTN events on the PSTN port 68 such as Off Hook, On Hook, Flash Hook, DTMF tones, Fax Tones, TTD tones; ii) generates PSTN signaling such as Ring, Dial Tone, Confirmation Tone, CAS Tone and in band caller ID; and iii) converts between PSTN audio media and digital audio media. The audio DSP 58 also provides echo cancellation and conference mixing of digital audio signals.

The VoIP client 60 comprises a signaling translation module 64 and a compression/decompression module 33 which, in combination, convert between: i) call signaling messages and digital audio media exchanged with the audio DSP 58 and ii) VoIP signaling and compressed audio media exchanged with remote VoIP devices via the network 12 and the LAN 52. The VoIP client 60 may receive its IP address from the DHCP server 44 and may utilize the translation service of the router module 27 when communicating with a remote VoIP endpoint over the internet 12.

The signaling translation module 64 converts between call signaling messages exchanged with the audio DSP 58 and the VoIP call signaling messages exchanged with the remote VoIP devices.

The compression/decompression module 33 operates algorithms which convert between the digital audio media exchanged with the audio DSP 58 and the compressed digital audio that may be transmitted over UDP/IP channels between the VoIP client 60 and a remote VoIP device 42 via the router module 27. Exemplary compression/decompression algorithms utilized by the compression/decompression module 33 include: i) algorithms that provide minimal (or no) compression (useful for fax transmission) such as algorithms commonly referred to as G.711, G.726; ii) very high compression algorithms such as algorithms commonly referred to as G.723.1 and G.729D; and iii) algorithms that provide compression and high audio quality such as algorithms commonly referred to as G.728, and G.729E.

Summary

It should be appreciated that the systems and methods discussed herein provide for a gateway to provide both IP layer and application layer network address and port translation services to a plurality of data clients (and to an embedded VoIP client) to enable each of such data clients and a VoIP module to share a single IP address assigned by a service provider.

Although the invention has been shown and described with respect to certain preferred embodiments, it is obvious that equivalents and modifications will occur to others skilled in the art upon the reading and understanding of the specification. For example, the exemplary embodiments discussed herein operate utilizing Session Initiation Protocols for media session signaling. However, it is readily apparent to those skilled in the art that the teachings of the present invention may also be implemented for other media session signaling protocols including MGCP, H.323, and other protocols that may become commonly used. The present invention includes all such equivalents and modifications, and is limited only by the scope of the following claims.

1. A gateway for exchanging IP frames with remote IP devices over a communication link to a frame switched network, the gateway comprising:
a wide area network interface coupled to the communication link for exchanging the IP frames with the remote IP devices;
a local area network interface for receiving outbound IP frames from each of a plurality of IP clients, each outbound IP frame comprising a local IP header and payload:
the IP header comprising:
an IP client socket comprising a client IP address and a client port number of the IP client; and
a destination socket comprising a remote device IP address and a port number of a remote IP device; and
a router module coupled between the local area network interface and the wide area network interface, the router module receiving each outbound IP frame from the local area network interface and providing a corresponding translated outbound IP frame to the wide area network interface;
the translated outbound IP frame comprising a translated IP client socket comprising a gateway IP address and a global port number of the gateway that uniquely associates with the IP client socket and:
the payload if the outbound IP frame is a data frame; and
translated payload if the outbound IP frame is a media session signaling frame.

2. The gateway of claim 1, wherein:
a media session signaling fame comprises at least one of:
a media session socket comprising the client IP address and a media port number of the IP client; and
a signaling contact socket comprising the client IP address and a signaling port number and
the translated payload comprises:
a translated media session socket if the media session signaling frame includes a media session socket, the translated media session socket comprising the gateway IP address and a translated media port number that uniquely associated with the media session socket; and
a translated signaling contact socket if the media session signaling frame includes a signaling contact socket, the translated signaling contact socket comprising the gateway IP address and a translated signaling port number that uniquely associated with the signaling contact socket.

3. The gateway of claim 2, wherein the router module further comprises a translation table for recording:
the global port number in unique association with the IP client socket;
the translated media port number in unique association with the media session socket; and
the translated signaling port number in unique association with the signaling contact socket.

4. The gateway of claim 1, wherein:
the router module comprises a frame handling module for comparing the payload of the outbound IP frame to a plurality of signaling frame pattern and determining that the outbound IP frame is a media session signaling frame if the payload matches a signaling frame pattern.

5. The gateway of claim 1, further comprising:
a payload translation database for storing each signaling frame pattern in association with translation instructions; and
a payload translation module for translating each socket of the payload that is identified for translation in the translation instructions.

6. A gateway for exchanging IP frames with remote IP devices over a communication link to a frame switched network, the gateway comprising:
a wide area network interface coupled to the communication link for exchanging the IP frames with the remote IP devices;
a local area network interface for receiving outbound IP frames from each of a plurality of IP clients, each outbound IP frame comprising a local IP header and payload:
the IP header comprising:
an IP client socket comprising a client IP address and a client port number of the IP client; and
a destination socket comprising a remote device IP address and a port number of a remote IP device; and
the payload comprising:
a media session socket comprising the client IP address and a media port number of the IP client;
a router module coupled between the local area network interface and the wide area network interface, the router module receiving each outbound IP frame from the local area network interface and providing a corresponding translated outbound IP frame to the wide area network interface, the translated outbound IP frame comprising both a global IP header and translated payload:
the global IP global header comprising a translated IP client socket comprising a gateway IP address and a global port number of the gateway that uniquely associates with the IP client socket;
the translated payload comprising a translated media session socket comprising the gateway IP address and a translated media port number that uniquely associates with the media session socket; and
the router module comprising a translation table for recording both:
the IP client socket in association with the global port number; and
the media session socket in association with the global media port number.

7. A gateway for exchanging IP frames with remote IP devices over a communication link to a frame switched network, the gateway comprising:
a wide area network interface coupled to the communication link for exchanging the IP frames with the remote IP devices;
a local area network interface for receiving outbound IP frames from each of a plurality of IP clients, each outbound IP frame comprising an IP header and payload, the local IP header comprising:
an IP client socket comprising a client IP address and a client port number of the IP client; and
a destination socket comprising a remote device IP address and a port number of a remote IP device;
a router module coupled between the local area network interface and the wide area network interface, the router module receiving each outbound IP frame from the local area network interface and providing a corresponding translated outbound IP frame to the wide area network interface, the router module comprising:
an IP layer translation module for:
generating the translated outbound IP frame in response to receiving an outbound IP frame, the translated outbound IP frame comprising a global IP header and payload, the global IP global header comprising:
a translated IP client socket comprising a gateway IP address and a global port number of the gateway that uniquely associates with the IP client socket; and
the destination socket; and
recording the IP client socket in association with the global port number in a translation table;
an application layer translation module for:
generating translated payload in response to detecting that the outbound IP frame comprises at least one of a media session socket and a signaling contact socket, the translated payload comprising:
a translated media session socket if the media session signaling frame includes a media session socket, the translated media session socket comprising the gateway IP address and a translated media port number that uniquely associated with the media session socket; and
a translated signaling contact socket if the media session signaling frame includes a signaling contact socket, the translated signaling contact socket comprising the gateway IP address and a translated signaling port number that uniquely associated with the signaling contact socket.

8. The gateway of claim 7, wherein the routing module further comprises a frame handling module for passing the outbound IP frame with the payload to the IP layer translation module in response to determining that the outbound IP frame is a data frame.

9. The gateway of claim 8, wherein the frame handling module compares the payload of the outbound IP frame to a plurality of signaling frame pattern to determine that the outbound IP frame is a media session signaling frame if the payload matches a signaling frame pattern.

10. The gateway of claim 7, wherein the routing module further comprises a translation table and the application layer translation module further provides for recording, in the translation table each of:
the global port number in unique association with the IP client socket;
the translated media port number in unique association with the media session socket; and
the translated signaling port number in unique association with the signaling contact socket.

11. A method of operating a gateway that supports multiple IP clients to effect the exchange of IP frames between a plurality of IP clients and remote IP devices over a communication link to a frame switched network, the method comprising:
receiving an outbound IP frame from each of a plurality of IP clients, each outbound IP frame comprising a local IP header and payload:
the local IP header comprising:
an IP client socket comprising a client IP address and a client port number of the IP client; and
a destination socket comprising a remote device IP address and a port number of a remote IP device; and
providing a corresponding translated outbound IP frame to the wide area network interface, the translated outbound IP frame comprising a translated IP client socket comprising a gateway IP address and a global port number of the gateway that uniquely associates with the IP client socket and:
the payload if the outbound IP frame is a data frame; and
translated payload if the outbound IP frame is a media session signaling frame.

12. The method of claim 11, wherein:
a media session signaling fame comprises at least one of:
a media session socket comprising the client IP address and a media port number of the IP client; and
a signaling contact socket comprising the client IP address and a signaling port number and
the translated payload comprises:
a translated media session socket if the media session signaling frame includes a media session socket, the translated media session socket comprising the gateway IP address and a translated media port number that uniquely associated with the media session socket; and
a translated signaling contact socket if the media session signaling frame includes a signaling contact socket, the translated signaling contact socket comprising the gateway IP address and a translated signaling port number that uniquely associated with the signaling contact socket.

13. The method of claim 12, further comprising recording, in a translation table:
the global port number in unique association with the IP client socket;
the translated media port number in unique association with the media session socket; and
the translated signaling port number in unique association with the signaling contact socket.

14. The method of claim 11, further comprising:
comparing the payload of the outbound IP frame to a plurality of signaling frame patterns; and
determining that the outbound IP frame is a media session signaling frame if the payload matches a signaling frame pattern.

15. The method of claim 11, further comprising:
translating each socket of the payload by identifying translation instructions associated with each signaling frame pattern in a payload translation database.

16. A method of operating a gateway that supports multiple IP clients to effect the exchange of IP frames between a plurality of IP clients and remote IP devices over a communication link to a frame switched network, the method comprising:
receiving each outbound IP frames from each of a plurality of IP clients, each outbound IP frame comprising a local IP header and payload:
the IP header comprising:
an IP client socket comprising a client IP address and a client port number of the IP client; and
a destination socket comprising a remote device IP address and a port number of a remote IP device; and
the payload comprising:
a media session socket comprising the client IP address and a media port number of the IP client;
providing a corresponding translated outbound IP frame to the wide area network interface, the translated outbound IP frame comprising both a global IP header (152) and translated payload:
the global IP global header comprising a translated IP client socket comprising a gateway IP address and a global port number of the gateway that uniquely associates with the IP client socket;
the translated payload comprising a translated media session socket comprising the gateway IP address and a translated media port number that uniquely associates with the media session socket; and
recording, in a translation table, both:
the IP client socket in association with the global port number; and
the media session socket in association with the global media port number.

17. A method of operating a gateway that supports multiple IP clients to effect the exchange of IP frames between a plurality of IP clients and remote IP devices over a communication link to a frame switched network, the method comprising:
receiving each outbound IP frames from each of a plurality of IP clients, each outbound IP frame comprising an IP header and payload, the local IP header comprising:
an IP client socket comprising a client IP address and a client port number of the IP client; and
a destination socket comprising a remote device IP address and a port number of a remote IP device;
providing a corresponding translated outbound IP frame to the wide area network interface by a process of:
generating the translated outbound IP frame in response to receiving an outbound IP frame, the translated outbound IP frame comprising a global IP header and payload, the global IP global header comprising:
a translated IP client socket comprising a gateway IP address and a global port number of the gateway that uniquely associates with the IP client socket; and the destination socket; and
generating translated payload in response to detecting that the outbound IP frame comprises at least one of a media session socket and a signaling contact socket, the translated payload comprising:
a translated media session socket if the media session signaling frame includes a media session socket, the translated media session socket comprising the gateway IP address (156) and a translated media port number (164) that uniquely associated with the media session socket (127); and
a translated signaling contact socket (155) if the media session signaling frame includes a signaling contact socket (124), the translated signaling contact socket (155) comprising the gateway IP address (156) and a translated signaling port number (166) that uniquely associated with the signaling contact socket (154).

18. The method of claim 17, further comprising generating the translated IP frame with the payload in response to determining that the outbound IP frame is a data frame.

19. The method of claim 18, wherein the step of determining whether the outbound IP frame is a media session signaling frame comprises comparing the payload of the outbound IP frame to a plurality of signaling frame pattern and determining that the outbound IP frame is a media session signaling frame if the payload matches a signaling frame pattern.

20. The method of claim 17, further comprising recording, in a translation table each of:
the global port number in unique association with the IP client socket;
the translated media port number in unique association with the media session socket; and
the translated signaling port number in unique association with the signaling contact socket.
